(19) United States
(12) Patent Application Publication
(10) Pub. No.: US 2003/0140038 A1
(43) Pub. Date: Jul. 24, 2003

(54) Search engine for computer graphic images

(76) Inventors: Philip Baker, Ottawa (CA); Simon Gregoire, Hull (CA); David Hood, Hull (CA); Marc-Antoine Benglia, Hull (CA)

Correspondence Address: Shapiro Cohen, P.O. Box 3440, Station D, Ottawa, ON, K1P 6P1, CA

(21) Appl. No.: 10/319,656

(22) Filed: Dec. 16, 2002

(30) Foreign Application Priority Data
Dec. 17, 2001 (GB) 0130132.4

(51) Int. Cl. G06F 7/00

(52) U.S. Cl. 707/3

(57) ABSTRACT

A method and system for searching databases having items indexed by multiple keywords that are indicative of the item being indexed for easy searching by having keyword lists that reference lists of items that fall under these specific keywords. These keyword lists reference item lists that indicate which item is under which keyword and how this item can be found in a database. The keyword lists are advantageously searched by storing them in a word tree where each node in the word tree is an element of a keyword. By traversing the word tree to arrive at a bottom node or at an intermediary node from which bottom nodes derive, partial and full keyword searches are performed. These keyword lists and their corresponding item lists are able to be cached at a user computer from which the user performs his or her search. Any items that match the search terms entered by the user can then be retrieved from a remote server.

### FIELD OF THE INVENTION

The present invention relates to computerized search engines and, more specifically, to methods and devices for searching a database with items indexed by keywords.

### BACKGROUND TO THE INVENTION

The field of computer technology has been rapidly expanding in the past few years, especially with respect to online databases and search engines for such databases. Internet search engines such as Google™ and Alta Vista™ provide search functions for users wishing to find web pages that are dedicated to specific topics. Other specialized search engines have also been used for searching through other databases that may or may not be online. One major problem with the current model of database searching has been the requirement that search terms be uploaded to a remote server for searching. Once these search terms reach the server, only then is a search performed for items that match the search term. This searching model has a number of distinct disadvantages. Specifically, this model becomes quite slow and tedious when multiple users are trying to perform simultaneous searches. The remote server, if there is only one, can easily get bogged down between the numerous simultaneous searches.

The above described model becomes even more onerous and problematic when it is applied to items in a database that do not easily lend themselves to text searches. As an example, computer graphic images are usually referenced by their file names. While the file name of a computer graphic image is normally indicative of the subject matter of the image, searching by file name is not the most efficient nor the most effective search method. Essentially, the space limitation for file names cannot possibly encompass the different possible classifications for a specific computer graphic image. A computer graphic image having the file name “Newyork.jpg” could be a graphic image of the skyline of New York city showing the Statue of Liberty and/or showing the Empire Sate Building. Unfortunately, this file name cannot possibly include the other categories under which the file could be classified. The file could also be categorized under the categories of skyline, statue (if the image shows the Statue of Liberty), tall building (if the image shows the Empire State Building), and city. A user who is searching for images of a large city would therefore have to know that images of New York are in the graphic image database and specifically search for New York. Similarly, a user looking for images of statues and/or tall buildings would look for, images of New York only if that person knew that tall buildings and large statues existed in New York. What this means is that a user performing a search for graphic images must necessarily import into the search a large amount of background information that he or she must have to conduct such a search properly based on file names alone. Not all users are equipped with such background information; uninformed users would therefore be in the unfortunate position of not being able to maximize their search for the relevant graphic images.

A further problem with searching databases relates to partial keyword searches. Certain search engines are able to search databases based on search terms that are not complete words but are only partial words. As an example, for some of these search engines, when the term “GAR” is entered, the search engine should be able to provide to the user hits on terms such as garden, garment, and garland. Unfortunately, these search engines are only able to do this by determining the beginning and the end of the search terms. The processing involved in performing word searches can be quite onerous especially if the database has a fairly large number of items that need to be searched.

Based on the above, there is a need for search and storage techniques that would render database searching faster and easier to accomplish. Furthermore, such search and storage techniques must allow for a more efficient and more effective partial word searches.

### SUMMARY OF THE INVENTION

The present invention seeks to meet the above need by providing methods and systems for searching databases having items indexed by keywords. A database with its items indexed by multiple keywords that are indicative of the item being indexed can easily be searched by having keyword lists that reference lists of items that fall under these specific keywords. These keyword lists reference item lists that indicate which item is under which keyword and how this item can be found in a database. Also, the keyword lists can easily be searched by storing them in a word tree where each node in the word tree is an element of a keyword. By traversing the word tree to arrive at a bottom node or at an intermediary node from which bottom nodes derive, partial and full keyword searches can easily be performed. These keyword lists and their corresponding item lists can be cached at a user computer from which the user performs his or her search. Any items that match the search terms entered by the user can then be retrieved from a remote server.

In a first aspect the present inventions provides a method for an end user to search a database having items indexed by at least one keyword, the method comprising:

a) transmitting a search element to a search engine, the search element being at least a portion of a keyword and having a predetermined minimum number of characters;

b) searching a letter tree using the search engine, the letter tree being a data structure with each node of the tree being a part of a keyword;

c) retrieving found keywords which match the search element;

d) retrieving indications representative of items being indexed by the found keywords; and

e) transmitting the indications to the end user who requested the search.

In a second aspect the present invention provides a method of searching for computer graphic images in a database containing images indexed by keywords, the method comprising:

a) entering at least one search element in a search engine located at a specific computer, the or each search element being at least a portion of a keyword having a predetermined minimum number of characters;

b) searching a keyword list on the specific computer for matches to the at least one search element;

c) retrieving found keywords which match the at least one search element;

d) determining which images in the database are indexed by the found keywords;

e) retrieving a thumbnail representation of images found in step d);

f) presenting the representations to a user at a client computer; and

g) storing the found keywords and the retrieved thumbnail representatives at the client computer for future searches.

In a third aspect the present invention provides computer readable media having encoded thereon computer readable and computer executable code comprising a software product for accessing and searching a database having items indexed by keywords, the software product having:

a searching module for searching keyword lists for at least one keyword for match to a given search element and for retrieving found keywords which match the search element;

a download/upload module for downloading from a server keyword lists to be searched and for downloading indications representative of items being indexed by the found keywords;

a caching module for caching keyword lists downloaded by the download/upload module and for caching indications downloaded by the download/upload module from the server; and

a presentation module for presenting to an end user at least one of the indications downloaded by the download/upload module;

wherein the searching module transmits the given search element to a server if a match is not found between the given search element and at least one keyword in a local keyword list.

### DETAILED DESCRIPTION OF THE DRAWINGS

A better understanding of the invention may be obtained by reading the detailed description of the invention below, in conjunction with the following drawings, in which:

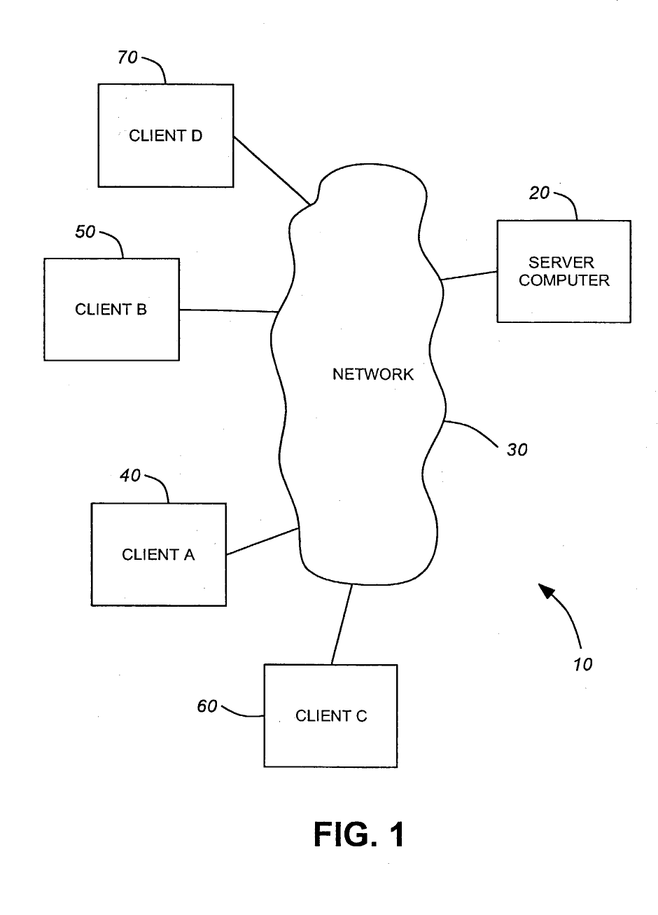

FIG. 1 is a block diagram of a system on which the system maybe practised;

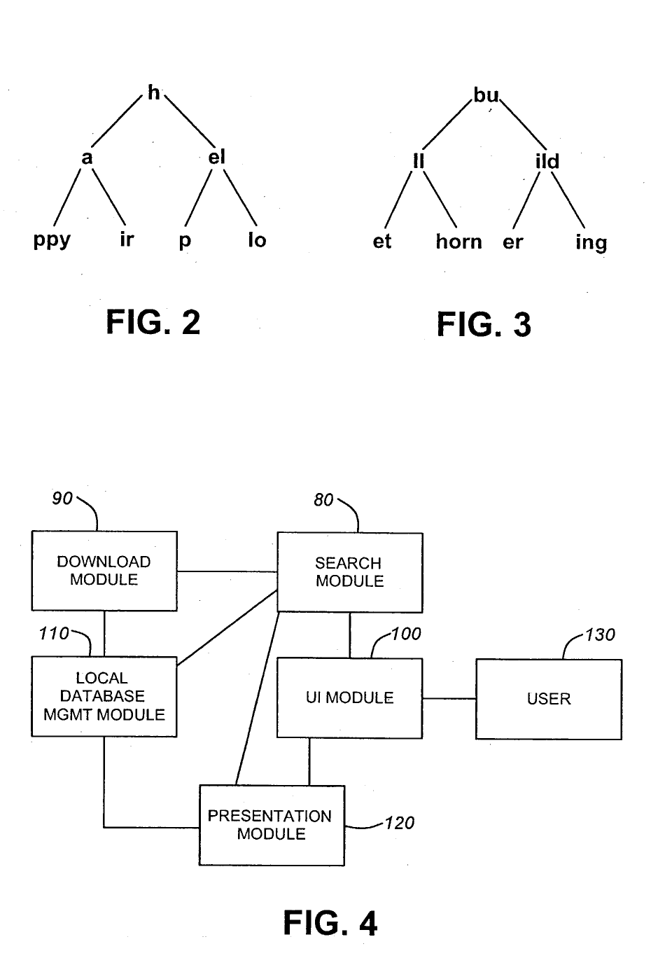

FIG. 2 is an example of a keyword tree list according to an aspect of the invention;

FIG. 3 is another example of a keyword tree list similar to that of FIG. 2;

FIG. 4 is a block diagram of software modules used by the one aspect of the invention; and

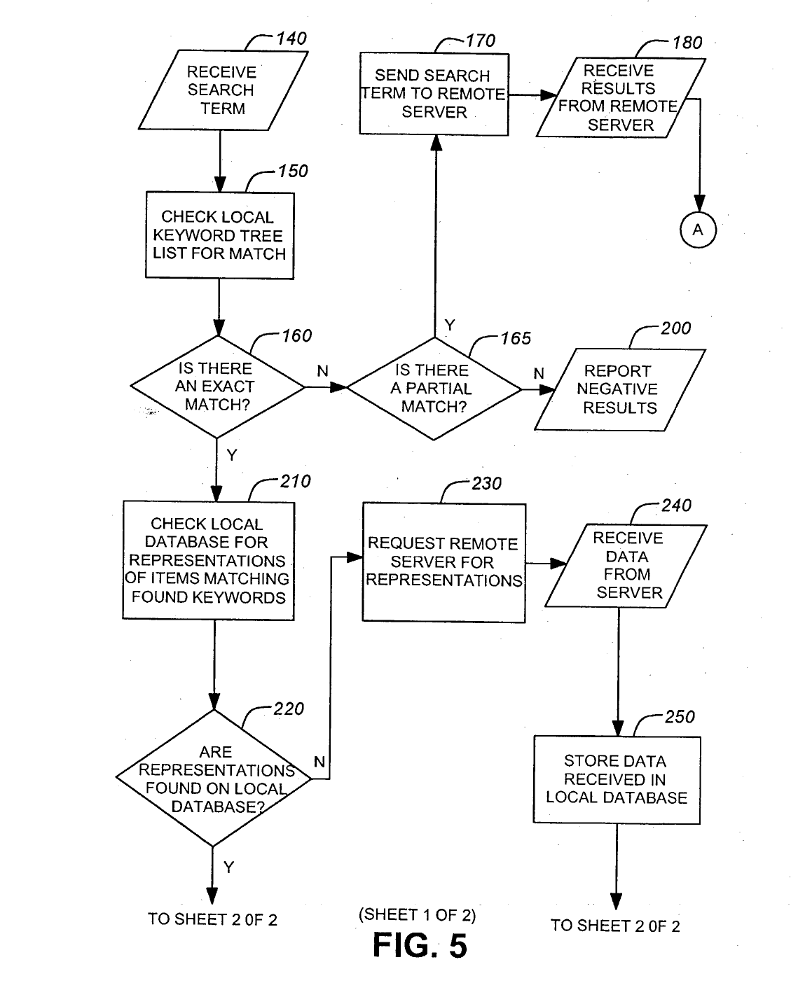

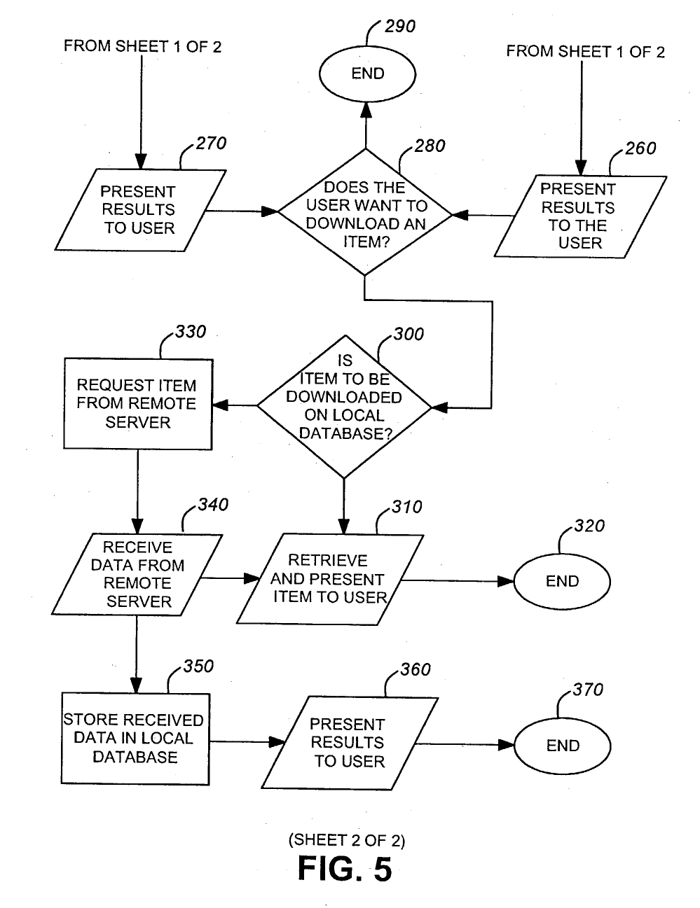

FIG. 5 is a flow chart illustrating the steps executed in the client computer according to one aspect of the invention.

### DETAILED DESCRIPTION

Referring to FIG. 1, a system 10 in which the invention may be practised is illustrated. A server computer 20 is in communication with a network 30 through which the server computer 20 communicates with multiple clients: client A 40, client B 50, client C 60, and client D 70. All of the client computers in FIG. 1 communicate with the server computer by way of the network 30. The network 30 can be a well known Local Area Network (LAN), a well known Wide Area Network (WAN), the Internet, or any network with a size between the size of the Internet and the size of a LAN.

Each client computer in FIG. 1 represents not only a client computer but also a user (not shown) at the client computer operating the client computer. The user by way of the client computer searches for items that he or she requires and the client computer communicates with the server computer 20 to download the user's desired item to the client computer.

A client, such as client A 40, first searches its own local database for a match between its user's search term and a keyword in the local database, and if there is a match with its own local database, the client A 40 then requests the desired item from server computer 20 if the item is not contained in the local database. Essentially when a user initiates a search, the client computer will perform a search for a match between the user's search terms and a keyword located in the client computer. If a match is found with the client computer local keyword list, then the client computer determines if the matching items are located in the local database. If the matching items are in the local database then these items are presented to the user. Otherwise, as noted above, if the matching items are not on the local database of the client computer, the matching items are retrieved from the server computer. In the event that matching items are located in both the server and the local database, these matching items can be presented to the user as a group.

To further understand the above process, it should be noted that the items that are located in either the server computer or in the client computer are referenced by keywords. As an example, if the items in the databases are computer graphic images, an image of the Empire State Building would be referenced by the keywords New York, skyscraper, empire, and landmark. Thus, a user wishing to find computer graphic images of buildings would enter the search term “skycraper” and accordingly the user would be presented with the search results which would include the computer graphic image for the Empire State Building. The keyword list would be searched for a match with the user's search term but the keyword list, in this embodiment, would not contain a list of matching items. A separate list, a keyword reference list, would have the list of the matching keywords. The keyword reference list would be a list of keywords and which items match those keywords. Following the example above, the image for the Empire State Building would therefore have multiple listing in the keyword reference list as the image matches multiple keywords. Thus, for the keyword “skyscraper”, images of the Sears Tower, the Empire State Building and the CN Tower would be listed. Similarly, under the keyword “landmark”, images of well known landmarks as the Empire State Building, the Eiffel Tower, the Space Needle, and the CN Tower would be included. Essentially, the client computer 40 would search its own keyword list for a match with the user's search term and, assuming there is a match, the client computer 40 would then check its own keyword reference list to determine which items are classified under the keyword that was found.

It should further be noted that it is preferable if the user only searches specific collections in the database. What this means is that the whole database is divided into specific sections and the user only searches at most a few collections at a time. This is done mainly in the interest of user convenience. If a user is only searching one collection then only the keyword reference list for that collection need be downloaded to the client computer. Furthermore, the keyword list for that collection is the only keyword list that needs to be searched. Rather than have the user search all collections simultaneously, the user can direct his or her search to a collection that is more directed at his or her subject.

To provide the system 10 with the capability of searching partial search terms, the keyword lists are stored in the form of a data structure called a tree list. What this means is that each keyword is broken down into specific units and by traversing the tree list or keyword tree, a match can be found between a search term and a word in the keyword list. By way of example, FIGS. 2 and 3 are provided. From FIG. 2, it can be seen that from the initial root letter h, four leaf nodes are derived in the example. From the root letter h, if the left branch is taken then the element “h a” is formed. From this element “h a”, two leaf nodes or, end nodes, “happy” and “hair” can be formed. Conversely, if the user enters merely the element “hel”, the client computer traverses the tree list from the element “h” to the elements “el” to form the element “hel”. Thus, for the user entering the search term “hel”, the search produces two possible matches: “help” and “hello”. Once these two possible matches are found, the items which correspond to these keywords can be presented to the user. Thus, if images are the items stored in the database, the images which correspond to the keyword “help” and the images which correspond to the keyword “hello” can be presented to the user or indications of such images, as will be explained below, can be presented to the user.

To further explain the system, each client computer is initially provided with a keyword tree and a keyword reference list. The keyword tree contains all the legitimate keywords recognized by the system and stored in a decomposed form in a tree. The keyword reference list contains the keywords and how many items reference each keyword and how these items can be accessed. Initially, the database in the client computer does not contain any items. The database is continuously populated as the user performs more searches. As an example, if the user enters the. search term “help”, then the system traverses the keyword tree to find the matching keyword “help”. Once the matching keyword is found, the local database (the database local to the client computer) is consulted to see if the matching items are cached in the client computer. Assuming the matching items are not cached in the client computer, the system will not find the matching items in the client computer database. When this occurs, the system will send the matching keyword to the remote server. The remote server will then receive the matching item (or their indications) from its database. These retrieved matching items will then be compared with the local database on the client computer. Any items already cached on the client computer database will not be downloaded to the client computer. The remaining matching items will then be downloaded to the client computer for representation to the user. Any items downloaded to the client computer becomes part of the client computer database.

From the above and because downloaded items become part of the local database, any subsequent searches that match items that are also referenced by the keyword “help” will be in the local database. Such searches will therefore be conducted faster as the matching items will no longer have to be downloaded to the client computer from the remote server. As will be explained below, if indications of the matching items are used, such indications can be presented to the user in a faster manner as such indications would have been cached in the client computer.

For partial keyword searches, the user must enter a search term that has a predefined minimum number of letters. As an example, if the minimum number of letters is 3, then if the user enters “hel”, the system will return all items which match keywords that begin with the element “hel”. If the only keywords which match this partial search term are the keywords “help” and “hello”, then the items matching these terms are presented to the user. The system accomplishes this by first determining if the search term entered matches a legitimate keyword by traversing the keyword tree. If a match is found, then it is assumed that he matching keyword is then user desired search term. Thus, if the user enters the term “church” then it is assumed that this is the user's desired search term and items matching the keyword “church” are retrieved. However, if the user, after entering “church” enters more letters to form the term “churchyard”, then the search narrows to the search term “churchyard”.

Once the system determines that no legitimate keyword matches the search term, then the partial search term is sent to the remote server. The remote server then finds all keywords (from its extensive keyword database) that contain the partial search term. The items which match these matching keywords are then downloaded to the client computer as required. If items which match the matching keywords are already cached in the client computer, then they are not downloaded.

Referring to FIG. 3 another example is provided. In this case, the root node is that of the element “bu”. If the user enters a search term for the keyword “bull”, the search would produce three results: the complete keyword “bull” along with a partial match for the keywords “bullet” and “bullhorn”. The user can then determine whether to proceed with merely the full keyword match for the term “bull” or to further constrain the search by adding to the search term to indicate either the keywords “bullet” or “bullhorn” for which there was a partial match. A similar case applies if the right branch is taken in the tree in FIG. 3. By concatenating the root node with the element “ild”, the term “build” is formed. While “build” is recognized as a legitimate English word, it may not be referenced as a recognized keyword in the system. As such, the system does not provide the user with any matches. If the user continues to type, then the search continues with the extra letters. If the user does not add any more letters, then the items which match the full keywords “building” and “builder” are presented to the user.

Once the keyword has been determined by traversing the tree list, the client computer can therefore check the keyword reference list to find the items that match the keyword found. As an added feature, each of the leaf nodes in FIGS. 2 and 3 (the nodes that are at the bottom of the tree) may contain the number of items matching that keyword for presenting to the user. The user can therefore determine if he or she wants to check further the keyword found. As an example, if the keyword “building” had 100 matching items the user may not wish to view all 100 items as this may involve lengthy download times. It should be noted that the search for the matching items starts as soon as the user is presented with the result count (the number of items matching the keyword). However, this search may be aborted if the user modifies the keyword to be searched. If this occurs, then the results are never shown. The only way to abort a search is by initiating a new search.

Once the client computer has determined which items match the found keyword by referring to the keyword reference list, the client computer can now present the search results to the user. To help in this process, the client computer can present to the user an indication of the items found. This indication merely serves as a piece of data indicative of the contents of the item found. As an example, if the items are computer graphic images, it would be quite onerous and inefficient to download the whole image and present this image to the user especially if there are multiple items. As such, in one embodiment, thumbnail images representative of the item found is presented to the user. A thumbnail image of a computer graphic image is merely a smaller version of the image. For example, an image that has a resolution of 640×480 pixels and uses 32,000 colours could be represented by an image that is only 10 pixels×10 pixels by 24 colours. While the resolution of the image suffers through the thumbnailing process, the thumbnail image enables identification of the full size image. Using this thumbnail image, the user can then determine whether the full size image is what he or she is looking for. As another example, if the items being searched for are text documents, the indication that can be sent to the user may perhaps be a short summary of the document contents, or the document first page.

It should be noted that indications for matching items are only downloaded as required. As an example, if the user's video settings can only show 30 thumbnails and there are 200 thumbnails that match the user's search term, then the thumbnails are only downloaded 30 at a time. Further thumbnails will be downloaded as the user scrolls through the thumbnail choices.

Even with the match for the keyword, it is conceivable that the client computer may not have a copy of the indication to be presented to the end user at its local database. If this is the case, then the client computer requests the server computer to send the required data. Once the user is presented with the indications, the end user can then determine which of the items found he or she wishes to examine further. The full item or items chosen by the end user are then downloaded to the client computer. In the embodiment explained above, the end user would choose some or none of the thumbnail images presented and these chosen thumbnail images would then be used by the client computer to download from the server computer the full sized images if the client computer does not already have these full sized images in its local database.

Referring to FIG. 4, a block diagram of software modules used in the invention is illustrated. As can be seen from the Figure, a search module 80 is operatively communicating with a download/upload module 90, a UI (User Interface)module 100, a local database management module 110, and a presentation module 120. The download/upload module 90 also communicates with the local database management 110 and the UI module 100. The UI module 100 also communicates with the user 130. The components illustrated in FIG. 4 works as follows. The user 130 inputs into the UI module an element of the keyword that has a minimum number of characters. The search term may be, in one embodiment, a minimum of three characters or multiple search terms separated by spaces or punctuation characters. The UI module then receives the search term and transmits it to the search module 80. Search module 80, as outlined above, checks a keyword tree. This is done by the search module 80 through communicating with the local database management module 110. If the search module does not find an exact match for the search term in the local keyword tree lists, a partial match is then searched for in the local keyword tree lists. If no partial match is found, then the negative results of the search (both full and partial) are presented to the user. If a partial match is found, the search term is sent to the download/upload module 90 for transmission to the server. Once the remote server receives the search term, this remote server then performs its own search on the search term from which a partial match was found and sends the results back to the download/upload module for transmission to the search module. The search module 80 then receives the results, and, depending on the results, transmits this data to the UI module 100 for presentation to the user 130. If the results received from the server include data indicative of the items found, then the search module transmits this indicative data to the presentation module for presentation to the user 130 by way of the UI module 100.

On the other hand, if the search module does find a match for the search term in the local database keyword tree list, then the search module retrieves the found keyword and representations of the items associated with that keyword from the local database through the local database management module. This data, which is indicative of the items found, is then transmitted to the presentation module 120 for presentation to the user by way of the UI module 100. In the event that the data representative of the items found is not located in the local database, the search module communicates with the download/upload module 90 to download from the remote server the data indicative of the items found. Such data is then received by the download/upload module 90, cached or stored in the local database by way of the local database management module 110 at the same time that this same data is presented to the user 130 by way of the presentation module 120 and UI module 100. Another function of the download/upload module is to periodically check if the keyword reference list is up to date. Each keyword reference list is assigned a version number and this version number is checked against the keyword reference list on the server. If the two numbers do not match, then the keyword list from the server is downloaded to the client computer on the assumption that the version on the server is the updated version.

The functions of the modules in FIG. 3 are as follows:

Download/upload module: the download/upload module communicates with the remote server; it transmits data to the remote server and receives data from the remote server. The download/upload module also routes any data from the remote server to the relevant modules such as the local database management module and/or the search module.

Local database management module: the local database management module, also known as the caching module, stores or caches the keyword tree lists that are used by the search module for searching. This local database management module also stores and manages the data downloaded by the download/upload module. Such data can include the representations of the items found by the search (e.g. thumbnail images instead of full size images), keyword reference lists that include the available keywords and the items that reference those keywords, and any items which may have been found and downloaded by the user. It should be noted that once the user has found the data he or she is looking for and has downloaded this data, such data can be cached or stored on the client computer by the local database management module. However, depending on the configuration that the system designer desires, there may be an upper limit as to the number of found items that are stored or cached by the local database management module. The local database management module also receives data from the download/upload module that the remote server has transmitted. This data can take the form of an updated keyword reference list, an updated keyword tree list, representations of the items found, and the items themselves.

Presentation module: the presentation module 120 receives data from the search module and/or the local database management module for presentation to the user 130. This function therefore provides the presentation module the freedom to scale, arrange, and place the data to be presented to the user 130. This data can include the representations of the data found by the search, the number of matching items matching a specific search term, the items which have been found and downloaded by the user 130, and any indications that the search has been unsuccessful.

UI module: the UI module receives data from the search module and/or the presentation module for displaying to the user 130. The UI module also receives user input for transmission to the search module 80.

Search module: the search module receives data from the UI module from the user. Specifically, the search module receives search terms from the user. Based on the search terms, the search module then can search the keyword lists that have been stored by the local database management module. In the event there is a match the search module or search engine then checks the found keyword against a keyword referenced list which documents which items are referenced by the found keyword. The items which are referenced by the found keyword can then be retrieved based on an input from the user but usually only after the search module has retrieved and presented the user indications of the items that have been found. As noted above, this includes retrieving, in one embodiment, thumbnail images of the items found and transmitting such images to the user by way of the presentation module 120 and the UI module 100. In the event there is no match between the search term and the keyword tree list maintained by the local database management module the search module then transmits the search term to the download/upload module for transmittal to the remote server. The search module also receives data from the download/upload module that the remote server has transmitted. This data can take the form of an updated keyword reference list, an updated keyword tree list, representations of the items found, the items themselves, and search results for searches conducted by the remote server.

It should be noted that the system designer may wish to subdivide the items to be searched into different collections. As noted above, this division into collections will allow for faster searches as the user may be limited to searching only one or two collections instead of the whole database stored in the remote server. Thus, in the example given above of a database of computer graphic images, the database may be divided into different collections based on subject matter, image resolution, or any other criteria. The user can be limited to only searching collections for which he or she has subscribed with the option of subscribing to other, larger collections. In such a model, the keyword tree list and the keyword reference list stored by the local database management module would therefore only relate to the collections within which the user may search. However, if the user wishes to perform a more in depth search and to subscribe to the other collections, then the remote server can transmit to the client computer the keyword tree lists and the keyword reference lists that relate to the collections to which the user is about to subscribe. As an example, the user may only subscribe to collection A and this means that the client computer on which the user is performing a search would only have keyword tree lists and keyword reference lists for collection A. However, if the user wishes to start subscribing to collections B and C, then the user will indicate this choice to the remote server. Once the usual payment and verification steps have been taken, the remote server can then transmit to the client computer the reference lists for collection B and C. The user can thus have the option of searching any one of the collections to which he or she has subscribed. This therefore means that, in addition to the search term that the user specifies, the user must also specify which collection he or she wishes to search. The search module can then search the proper keyword tree list and the proper keyword reference list based on which collection the user wishes to search.

The above system not only provides for quick searches due to the use of the keyword tree list and the use of the keyword reference list, but it also allows for the facilitation of updates to the database being searched. Essentially, if the database is to be updated with more items which can be searched, all the remote server has to do is to transmit updated keyword tree lists and an updated keyword reference list that contains any new keywords added and/or any new items which have been added. To ensure that the client computer is working with the latest version of the keyword tree list or the keyword reference list, the client computer could communicate with the remote server to determine if any updates have been entered prior to any searching. If there have been any updates which the client computer has not been appraised of, then the client computer can download the updated keyword tree list and/or keyword reference list. This way, the user is always using the most recent version of the keyword lists and therefore any search to be conducted is based on the latest version of the database stored in the remote server. In one embodiment, to assist in the updating of the local keyword lists, only the updated keyword lists are downloaded to the client computer. Thus, one update on the server does not invalidate all the client keyword lists. Similarly, if changes in the keyword tree are made, an updated keyword tree is downloaded to the client computer.

Referring to FIG. 5, a flow chart illustrating the steps executed in the client computer for a search is illustrated. The process begins at step 140 with the search term being input by the user. After this, (Step 150) the keyword tree list is checked by the client computer for a match with the search term. Step 160 then checks to see if a match is found between the search term and the local keyword tree list that was checked in step 150. If an exact match was not found, then step 165 checks if there is a partial match. If there is a partial match, step 170 transmits the search term to the remote server. The results from the remote server are received in step 180 connector A then notes that the next step is that of step 210. If a partial match was not found then the results are reported to the user (step 200). Step 210 is the step taken if the decision in step 160 was positive.

Step 210 involves checking the local database for each representation of each of the items matching the found keyword. Step 220 then decides if the representations (e.g, the thumbnail images) were found on the local database. If these representation are not found on the local database, then step 230 requests that the remote server transmit the data to the client computer. The data is then received from the server by the client computer in step 240 and cached in the client computer in step 250. Step 260 then presents the results to the user. If, on the other hand, the decision in step 220 is positive, then step 270 presents the representations found on the local database to the user. Step 280 is then the step followed after either of steps 260 or 270. Step 280 involves determining if the user wants to download an item that was presented to him or her after a successful search. If the user does not wish to download such an item then step 290 ends the process. Conversely, if the user wishes to download such an item then the client computer checks to see if the requested item can be found on the local database in step 300. If the item is found on the local database, then step 310 is that of retrieving and presenting the item to the user and ending the process in step 320. If on the other hand, step 300 results in a negative response then step 330 requests the item from the remote server. In step 340 data is received from the remote server and in step 350 this data is cached or stored in the local computer. Step 360 presents the data to the user and step 370 terminates the process.

It should be noted that the interactivity of the search process is a significant part of the process. Once a predetermined minimum number of characters is entered by a user, a search for that full or partial search term is initiated. However, if the user continues to add more characters to the search term, the initiated search is interrupted and a new search is automatically initiated on the resulting new search term. From the above example, if the search term “bull” is entered, then a search for that term is initiated. If the user adds the letter “h” to arrive at “bullh” then a search for “bullh” as the search term is initiated, interrupting the search for the term “bull”. If the user continues to add characters and arrives at the term “bullho” then the search for the term “bullh” is interrupted and a search for the term “bullho” is initiated.

It should be noted that while the above discussion mentions letter trees and keywords, the terms letter and keyword should not be taken as merely applying to letters. Any alphanumeric character can be used in a keyword, keyword reference list, keyword list, or letter tree.

While the above description refers to a search for a match to a single search term, multiple search terms can be searched for by performing searches on each search term and performing Boolean logic operations, such as “AND” and “OR” operation, on the search results of the different searches. Thus, as an example, if a user were to search using the search terms “CAT DOG” then two searches would be performed: one for the search term “CAT” and another for the search term “DOG”. Once the results for both searches have been received by the client computer, and “AND” operation can then be performed on the results. Thus, any search result that had both keywords “CAT” and “DOG” would be presented to the user. Alternatively, if an “OR” operation was the desired Boolean operation, then a search result that had either of the keywords “CAT” or “DOG” would be presented to the user.

Embodiments of the invention may be implemented in any conventional computer programming language. For example, preferred embodiments may be implemented in a procedural programming language (e.g. “C”) or an object oriented language (e.g. “C++”). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web).

Although various exemplary embodiments of the invention have been disclosed, it should be apparent to those skilled in the art that various changes and modifications can be made which will achieve some of the advantages of the invention without departing from the true scope of the invention.

We claim:

1. A method for an end user to search a database having items indexed by at least one keyword, the method comprising:
a) transmitting a search element to a search engine, the search element being at least a portion of a keyword and having a predetermined minimum number of characters;
b) searching a letter tree using the search engine, the letter tree being a data structure with each node of the tree being a part of a keyword;
c) retrieving found keywords which match the search element;
d) retrieving indications representative of items being indexed by the found keywords; and
e) transmitting the indications to the end user who requested the search.

2. A method as in claim 1 further including storing the indications in a client computer.

3. A method as in claim 1 wherein the indications are retrieved from either the database or from a cache in the client computer containing previously retrieved indications.

4. A method as in claim 1 wherein the items are graphic images.

5. A method as in claim 1 wherein the indications are thumbnail images of the graphic images.

6. A method as in claim 1 wherein the method is executed as soon as the search element has the predetermined minimum number of characters.

7. A method as in claim 6 wherein the method is restarted every time an extra character is added to the search term.

8. A method of searching for computer graphic images in a database containing images indexed by keywords, the method comprising:
a) entering at least one search element in a search engine located at a specific computer, the or each search element being at least a portion of a keyword having a predetermined minimum number of characters;
b) searching a keyword list on the specific computer for matches to the at least one search element;
c) retrieving found keywords which match the at least one search element;
d) determining which images in the database are indexed by the found keywords;
e) retrieving a thumbnail representation of images found in step d);
f) presenting the representation to a user at a client computer; and
g) storing the found keywords and the retrieved thumbnail representation at the client computer for future searches.

9. A method as in claim 8 wherein the specific computer is the client computer.

10. A method as in claim 9 further including the step
b1) in the event no matches are found to the at least one search element, performing steps a) & b) using a search engine at a server computer.

11. A method as in claim 8 wherein the thumbnail representations are retrieved from the client computer.

12. A method as in claim 8 wherein the thumbnail representatives are retrieved from a server computer.

13. A method as in claim 8 wherein the specific computer is a server computer.

14. A method as in claim 8 wherein the keyword list is stored as a letter tree, the letter tree being a data structure with each node of the tree being a part of a keyword.

15. A method as in claim 14 wherein step b) is accomplished by searching the letter tree.

16. A method as in claim 8 wherein the method is executed as soon as the search element has the predetermined minimum number of characters.

17. A method as in claim 16 wherein the method is executed as soon as the search element has the predetermined minimum number of characters.

18. Computer readable media having encoded thereon computer readable and computer executable code comprising a software product for accessing and searching a database having items indexed by keywords, the software product having:
a searching module for searching keyword lists for at least one keyword for match to a given search element and for retrieving found keywords which match the search element;
a download/upload module for downloading from a server keyword lists to be searched and for downloading indications representative of items being indexed by the found keywords;
a caching module for caching keyword lists downloaded by the download/upload module and for caching indications downloaded by the download/upload module from the server; and
a presentation module for presenting to an end user at least one of the indications downloaded by the download/upload module;
wherein the searching module transmits the given search element to a server if a match is not found between the given search element and at least one keyword in a local keyword list.

19. Computer readable media as claimed in claim 18 wherein the keyword lists are stored in a letter tree, a letter tree being a data structure with each node of the tree being a part of a keyword.

20. Computer readable media as in claim 18 wherein each search element is a portion of a keyword and having a predetermined minimum number of characters.

21. Computer readable media as in claim 18 wherein the items are graphic images.

22. Computer readable media as in claim 21 wherein the indications are thumbnail images of the graphic images.

23. Computer readable media as in claim 18 wherein the code implements a method comprising:
a) transmitting a search element to a search engine, the search element being at least a portion of a keyword and having a predetermined minimum number of characters;
b) searching a letter tree using the search engine, the letter tree being a data structure with each node of the tree being a part of a keyword;
c) retrieving found keywords which match the search element;
d) retrieving indications representative of items being indexed by the found keywords; and
e) transmitting the indications to the end user who requested the search.

24. Computer readable media as in claim 23 wherein the method is executed as soon as the search element has the predetermined minimum number of characters.

25. Computer readable media as in claim 24 wherein the method is restarted every time an extra character is added to the search term.
